(19) United States
(12) Patent Application Publication
(10) Pub. No.: US 2016/0171565 A1
(43) Pub. Date: Jun. 16, 2016

(54) Method for Raising Awareness and Fundraising for Eye-Related Medical Conditions

(71) Applicant: Robert E. Morris, Birmingham, AL (US)

(72) Inventor: Robert E. Morris, Birmingham, AL (US)

(21) Appl. No.: 14/967,190

(22) Filed: Dec. 11, 2015

Related U.S. Application Data
(60) Provisional application No. 62/090,831, filed on Dec. 11, 2014.

(51) Int. Cl. G06Q 30/02; G06Q 50/00; G06Q 99/00

(52) U.S. Cl. CPC G06Q 30/0279; G06Q 99/00; G06Q 50/01

(57) ABSTRACT

A method for raising awareness and raising funds for an eye-related medical problem by wearing an eye patch utilizes a plurality of human-shaped figures and a plurality of eye patches. Each of the plurality of eye patches is mounted onto a corresponding figure from the plurality of human-shaped figures. The plurality of human-shaped figures can either be an actual user or a mannequin. By mounting and positioning the plurality of eye patches on the plurality of human-shaped figures, real life eye-related medical problems such as blindness is simulated. In addition to raising awareness through simulation, the plurality of eye patches is also used for fundraising. Organizing events in which the users wear the plurality of eye patches is one such way of raising funds for the eye-related medical problem.

The current application claims a priority to the U.S. Provisional Patent application Ser. No. 62/090,831 filed on Dec. 11, 2014.

### FIELD OF THE INVENTION

The present invention relates generally to a method of raising awareness for a medical condition. More specifically, the present invention is intended to raise awareness of eye-related medical conditions. By utilizing the present invention, a larger audience can be addressed effectively.

### BACKGROUND OF THE INVENTION

Crowdfunded projects are a common occurrence today. These crowdfunded projects raise the necessary funds through fundraising campaigns and awareness campaigns. Fundraising campaigns directly request the audience to contribute towards the purpose of the crowdfunded project. On the other hand, awareness campaigns help spread the word regarding the crowdfunded project in expectation of receiving funds. The methods of raising funds and spreading awareness have a considerable impact on the success of the crowdfunded project.

Many fundraising projects do not live up to expectations for certain reasons. One of the main reasons is the limited knowledge an individual possesses regarding the issue at hand. When considering an example in the medical field, many individuals would not have first-hand experience regarding most medical conditions. Resultantly, the attention given to these medical conditions can also be minimum. In order to address the issue, fundraisers or any other awareness campaign needs to focus on providing first-hand experience to the individuals who do not have the addressed medical condition. Providing such first-hand experience can help persuade the healthy individual to either contribute to the fundraising project or spread awareness regarding the addressed medical condition.

Reaching a considerable audience has a large effect on the success of a fundraising project or an awareness campaign. In other words, the amount of received funds proportionately increases with the number of individuals reached through the fundraising project. Likewise, the number of individuals who are informed about an issue increases with the number of people reached through the awareness campaign. With developments in information technology and printed media a message can be conveyed to a large audience instantly. However, the message can be stagnant within a certain area with limited access to internet or printed media. Therefore, effective means need to be implemented into the fundraising project so that a larger crowd can be reached with the equal effectiveness.

Another drawback of the existing fundraising projects is the nature of the fund raising project. Most fundraisers come in the form of a written application that lacks physical involvement. As proven in the past, fundraising projects in which the user actively participates are more likely to be successful than other fundraising projects in which the users are not actively involved. Therefore, user involvement needs to be directly addressed in future fundraising projects.

The objective of the present invention is to address the aforementioned issues. In particular, the present invention introduces a novel method of raising awareness and raising funds for eye-related medical problems. In doing so, the present invention addresses a larger audience within a short time period which is beneficial to the success of a fundraising project or an awareness campaign. Moreover, the present invention ensures that the donors experience the eye-related medical problem through simulation.

### BRIEF DESCRIPTION OF THE DRAWINGS

FIG. 1 is a flowchart illustrating the basic overall process of the present invention.

FIG. 2 is a flowchart illustrating the basic overall process of mounting the plurality of eye patches with a headband.

FIG. 3 is a flowchart illustrating the basic overall process of mounting the plurality of eye patches with a temporary, skin-friendly adhesive.

FIG. 4 is a flowchart illustrating the basic overall process of partially covering the eye-shaped portion.

FIG. 5 is a flowchart illustrating the basic overall process of completely covering the eye-shaped portion.

FIG. 6 is a flowchart illustrating the basic overall process of printing a distinctive visual design on a front surface of each of the plurality of eye patches.

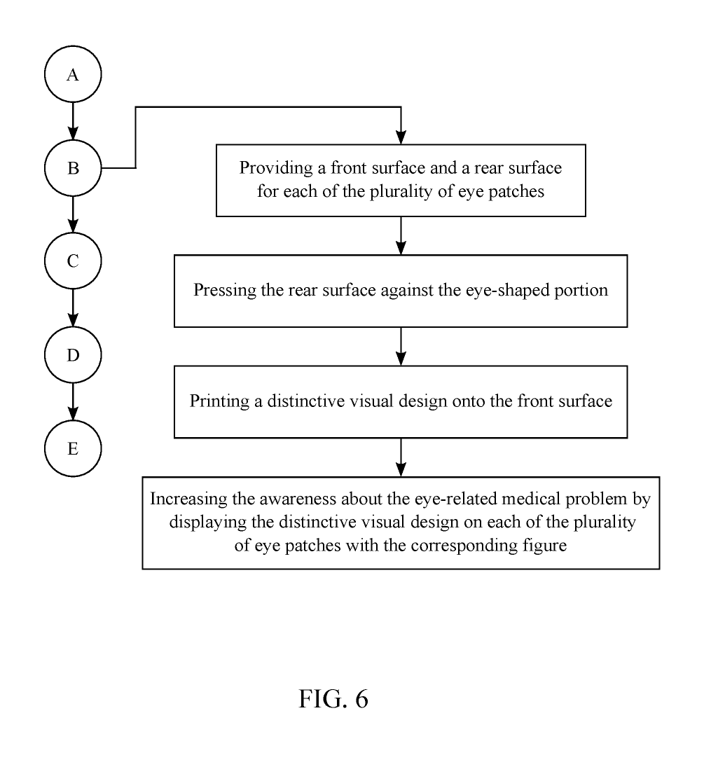

FIG. 7 is a flowchart illustrating the basic overall process of fundraising by selling the plurality of eye patches.

FIG. 8 is a flowchart illustrating the basic overall process of fundraising by displaying the plurality of eye patches.

FIG. 9 is a flowchart illustrating the basic overall process of raising awareness by uploading a photograph to a computerized social network.

FIG. 10 is an illustration of the eye patch being mounted onto the corresponding figure.

### DETAIL DESCRIPTIONS OF THE INVENTION

All illustrations of the drawings are for the purpose of describing selected versions of the present invention and are not intended to limit the scope of the present invention.

The present invention introduces a method of raising awareness and fundraising for eye-related medical problems. By utilizing the present invention, many negative issues prevalent with traditional fundraising projects and awareness campaigns can be avoided. As a result, a higher level of success can be reached by utilizing the method introduced by the present invention.

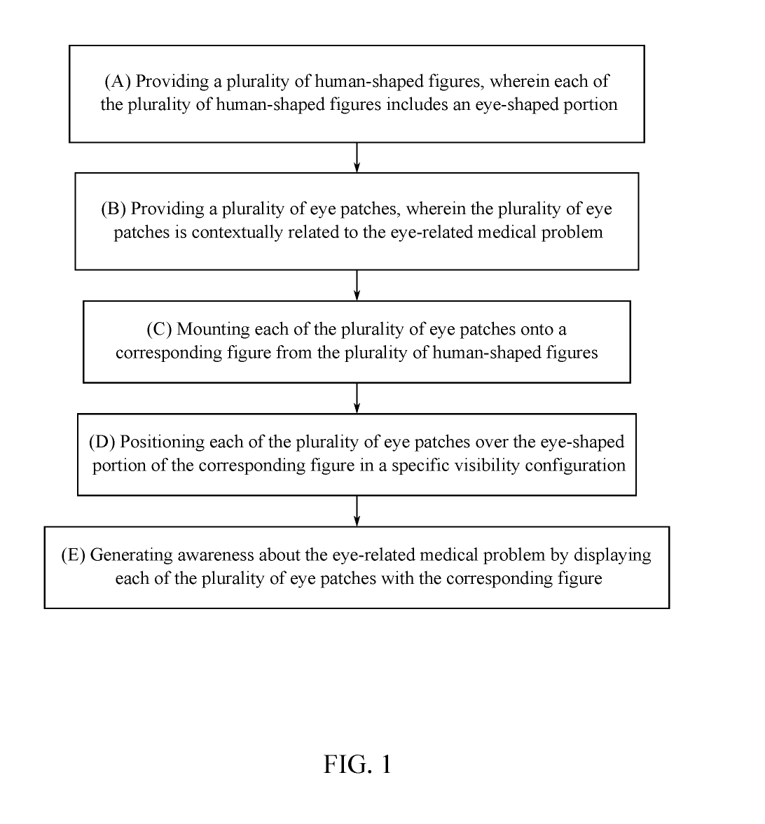

As mentioned earlier, the present invention addresses eye-related medical problems. In order to successfully address the issue, the present invention initially provides a plurality of human-shaped figures. The plurality of human-shaped figures can be either people or a plurality of mannequins. As seen in FIG. 1, each of the human-shaped figures includes an eye-shaped portion so that the eye-related medical problem can be directly addressed by using the plurality of human-shaped figures. For example, the eye-shape portion of a person is just one of their eyes, or the eye-shaped portion of a mannequin is a stand-still portion of the mannequin that is contoured like a human eye. The present invention also provides a plurality of eye patches, wherein each of the eye patches is contextually related to the eye-related medical problem. The plurality of eye patches can vary in size, shape, and material in different embodiments of the present invention.

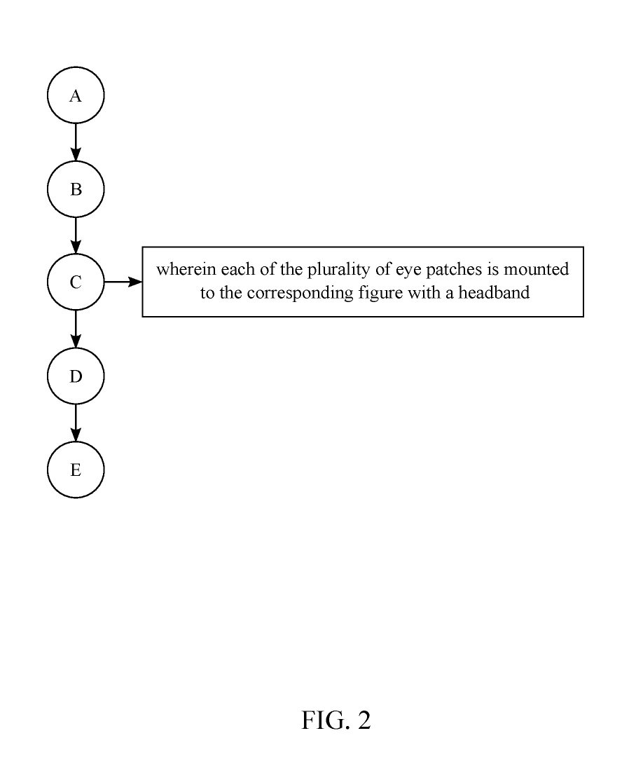

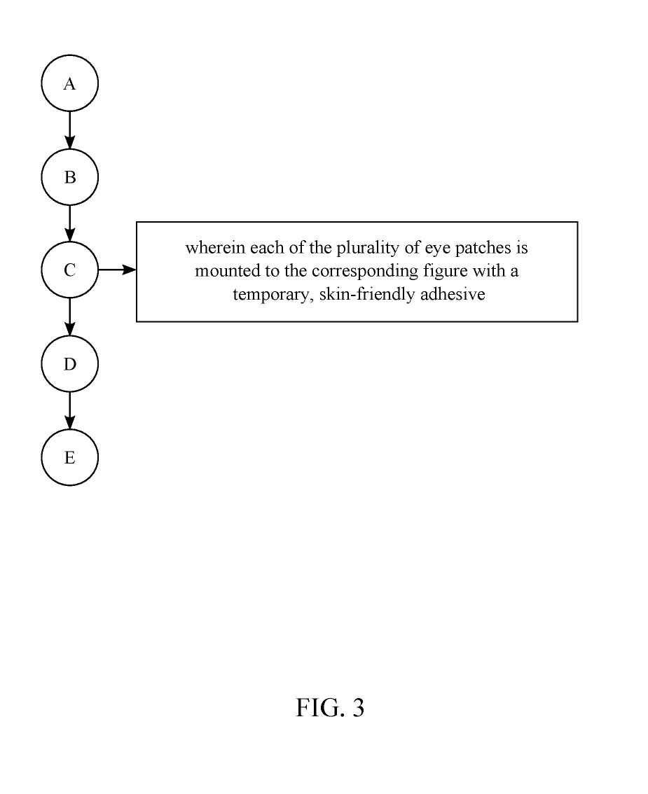

Each of the plurality of eye patches is mounted onto a corresponding figure from the plurality of human-shaped figures. The mounting can vary in different embodiments of the present invention. As in FIG. 2, in one embodiment of the present invention, each of the plurality of eye patches can be mounted to the corresponding figure with a headband. In particular, the headband can be positioned around a head-shaped portion of the corresponding figure such that each of the plurality of eye patches is appropriately placed. In another embodiment of the present invention, each of the plurality of eye patches can be mounted to the corresponding figure with a temporary, skin-friendly adhesive as shown in FIG. 3. The temporary nature of the adhesive is important so that each of the plurality of eye patches can be conveniently removed after use. On the other hand, the skin-friendly nature is important so that the human-shaped figures are not harmed when each of the plurality of eye patches are mounted.

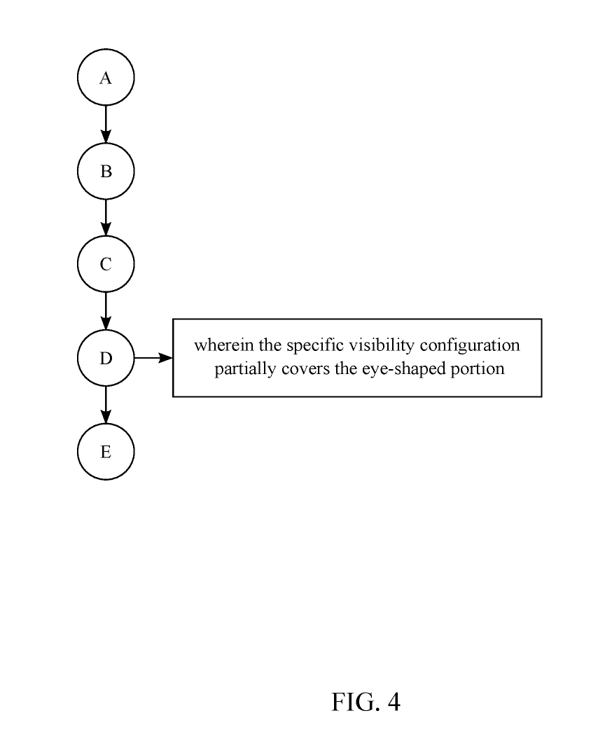

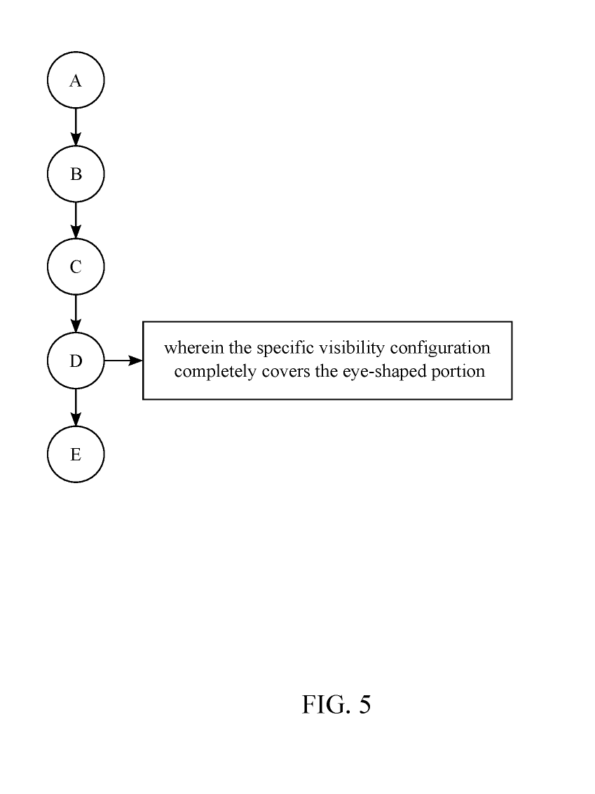

After mounting, each of the plurality of eye patches is positioned over the eye-shaped portion of the corresponding figure in a specific visibility configuration. More specifically, the specific visibility configuration differs according to the condition simulated by each of the plurality of eye patches. As an example, if partial blindness in an eye is simulated, the specific visibility configuration partially covers the eye-shaped portion as illustrated in FIG. 4. On the other hand, if complete blindness in the eye is simulated, the specific visibility configuration completely covers the eye-shaped portion as in FIG. 5. Additionally, each of the plurality of eye patches can also be designed differently to simulate the eye-related medical problem. As an example, a medical condition such as color blindness can be simulated by manufacturing each of the plurality of eye patches with color filtering material. By mounting and positioning each of the plurality of eye patches on the corresponding figure, the present invention simulates real life eye-related medical problems. Additionally, the present invention generates awareness about the eye-related medical problem by displaying each of the plurality of eye patches with the corresponding figure.

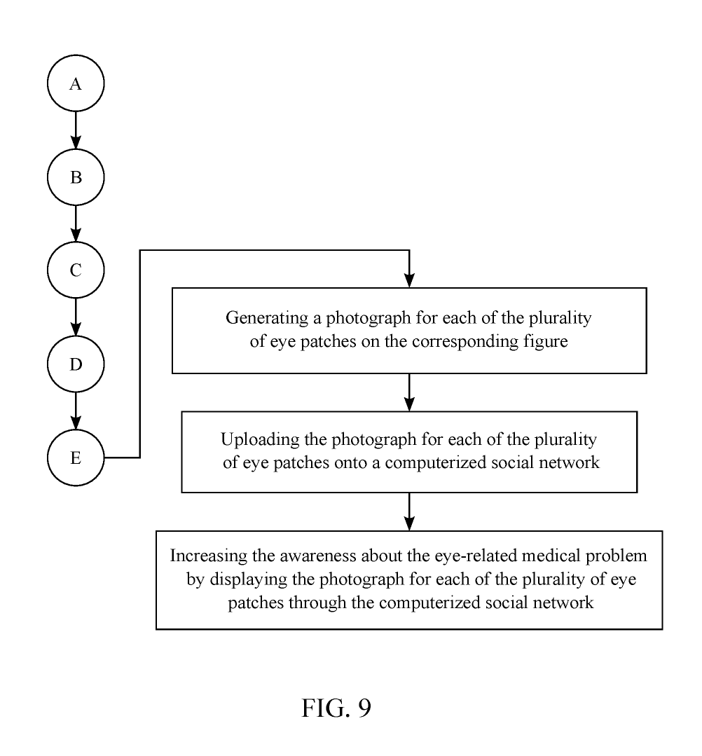

In another attempt of raising awareness for the eye-related medical problem, the present invention generates a photograph for each of the plurality of eye patches on the corresponding figure. Upon generating the photograph, the present invention uploads the photograph for each of the plurality of eye patches onto a computerized social network as seen in FIG. 9. The computerized social network can be any kind of social media or social networking that is hosted by a server system. The computerized social network allows the present invention to reach a large audience within a limited time period. To be more specific, the present invention increases awareness about the eye-related medical problem by displaying the photograph for each of the plurality of eye patches through the computerized social network. Even though the given example is described for a photograph, the present invention can also be used to generate other media files such as video and audio in other embodiments of the present invention. For instance, the present invention can generate a video for each of the plurality of eye patches on the corresponding figure. In another embodiment, the present invention can generate an audio file describing each of the plurality of eye patches on the corresponding figure. The connectivity of the computerized social network helps bring more awareness to the eye-related medical problem.

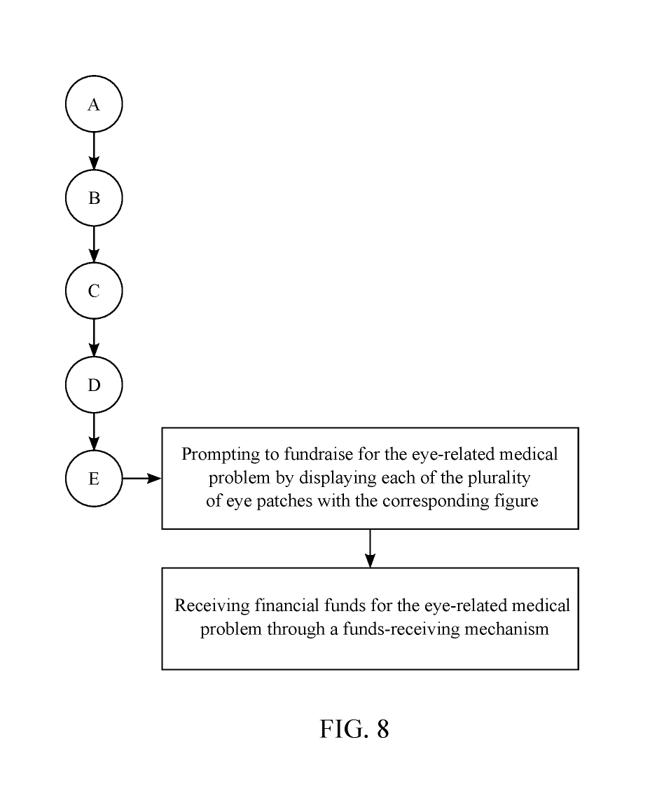

As previously mentioned the present invention is intended to be used not only for awareness campaigns, but also for fundraising purposes. As illustrated in FIG. 8, the present invention prompts to fundraise for the eye-related medical problem by displaying each of the plurality of eye patches with the corresponding figure. As an example, a social gathering can be organized where each of the plurality of eye patches is mounted to the corresponding figure from the plurality of human-shaped figures. The social gathering can be organized in conjunction with another significant event. As an example, the social gathering can be organized to commemorate the birth of Hellen Keller since the present invention is related to eye-related medical problems. Afterwards, the proceeds from the social gathering are directed towards fundraising for the eye-related medical problem. In other words, the present invention receives financial funds for the eye-related medical problem through a funds-receiving mechanism, which is the means for collecting the proceeds from the social gathering. Even though the social gathering is explained in this example, other activities such as games and competitions can also be organized to similarly involve the plurality of eye patches in increasing awareness about the eye-related medical problems.

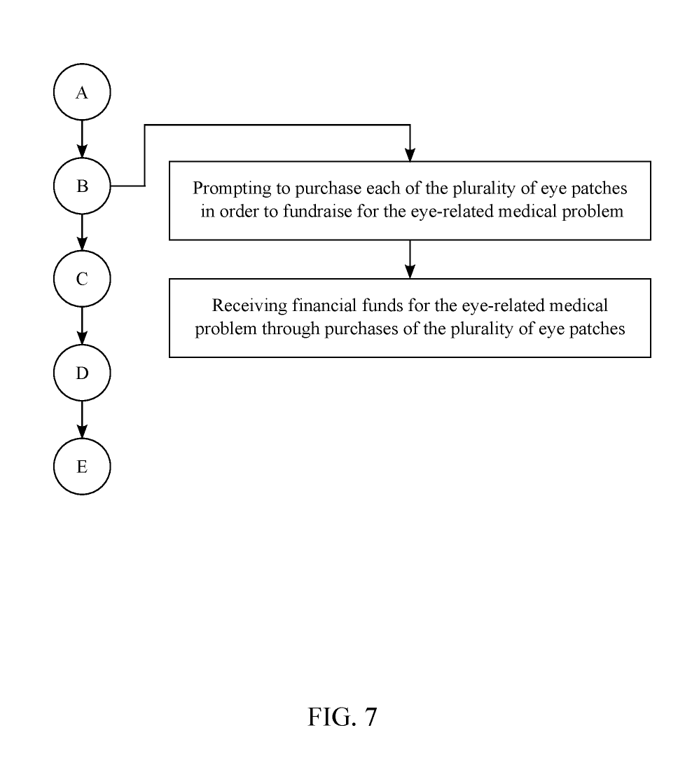

In addition to fundraising by displaying the plurality of eye patches, fundraising can also be done by selling the plurality of eye patches. As seen in FIG. 7, the present invention prompts to purchase each of the plurality of eye patches in order to fundraise for the eye-related medical problem. Afterwards, the funds received from selling the plurality of eye-patches is directed toward fundraising for the eye-related medical problem. More specifically, the present invention receives financial funds for the eye-related medical problem through purchases of the plurality of eye patches.

The plurality of eye patches can also be used to fundraise by promoting advertisements or sponsorships. In the present invention, each of the plurality of eye patches is provided with a front surface and a rear surface. When using each of the plurality of eye patches on the corresponding figure, the rear surface is pressed against the eye-shaped portion. Resultantly, the front surface is left completely exposed and can be used for promotional activities. In order to do so, each eye patch is imprinted with a distinctive visual design onto the front surface. The distinctive visual design can be a logo or other comparable design which helps promote a certain individual or a certain company. Therefore, the plurality of eye patches can be used to raise funds from the individual or company represented by the distinctive visual design. Simultaneously, the present invention also increases the awareness about the eye-related medical problems by displaying the distinctive visual design on each of the plurality of eye patches with the corresponding figure.

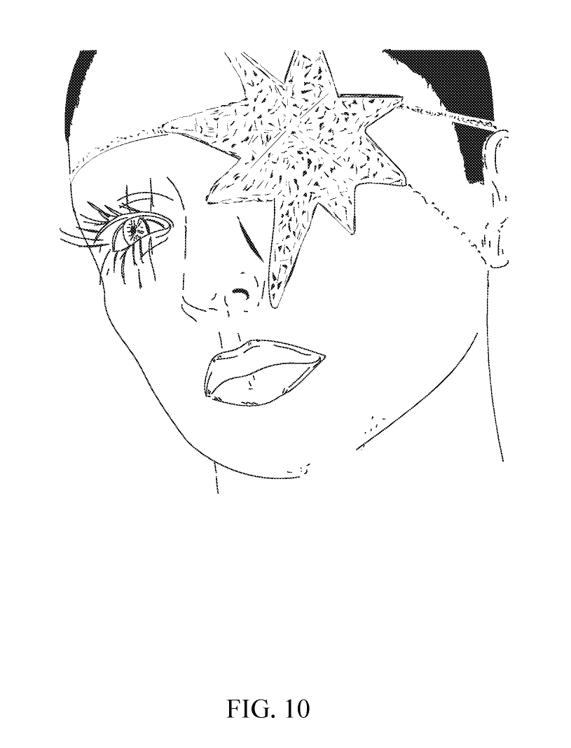

When the method of the present invention is put to use, the corresponding figure can be either a human user or a mannequin. As a first step of utilizing the present invention, each of the plurality of eye patches is mounted onto the corresponding figure. Mounting the plurality of eyes patches is done using the headband or the temporary, skin-friendly adhesive. Upon mounting, each of the plurality of eye patches is positioned over the eye in the specific visibility configuration such that the eye is partially covered or completely covered. FIG. 10 is an illustration of the specific visibility configuration completely covering the eye. When each of the plurality of eye patches is mounted and positioned over the eye, the user gets an understanding of the conditions an individual with the eye-related medical problem experiences. Therefore, the plurality of eye patches help spread awareness of blindness, partial blindness, and other eye-related medical conditions. The user can also spread awareness by uploading media content related to the plurality of eye patches on the computerized social media network. On the other hand, the plurality of users can raise funds for the eye-related medical problem by wearing the plurality of eye patches as part of a fundraising project or by purchasing the plurality of eye patches. Moreover, fundraising is also done by printing distinctive visual design on the front surface. The raised funds are then directed towards, medical expenses, vision research or any other vision-related field.

Although the invention has been explained in relation to its preferred embodiment, it is to be understood that many other possible modifications and variations can be made without departing from the spirit and scope of the invention as hereinafter claimed.

What is claimed is:

1. A method of raising awareness and fundraising for an eye-related medical problem, the method comprises the steps of:
providing a plurality of human-shaped figures, wherein each of the plurality of human-shaped figures includes an eye-shaped portion;
providing a plurality of eye patches, wherein the plurality of eye patches is contextually related to the eye-related medical problem;
mounting each of the plurality of eye patches onto a corresponding figure from the plurality of human-shaped figures;
positioning each of the plurality of eye patches over the eye-shaped portion of the corresponding figure in a specific visibility configuration; and
generating awareness about the eye-related medical problem by displaying each of the plurality of eye patches with the corresponding figure.

2. The method of raising awareness and fundraising for an eye-related medical problem, the method as claimed in claim 1, wherein each of the plurality of eye patches is mounted to the corresponding figure with a headband.

3. The method of raising awareness and fundraising for an eye-related medical problem, the method as claimed in claim 1, wherein each of the plurality of eye patches is mounted to the corresponding figure with a temporary, skin-friendly adhesive.

4. The method of raising awareness and fundraising for an eye-related medical problem, the method as claimed in claim 1, wherein the specific visibility configuration partially covers the eye-shaped portion.

5. The method of raising awareness and fundraising for an eye-related medical problem, the method as claimed in claim 1, wherein the specific visibility configuration completely covers the eye-shaped portion.

6. The method of raising awareness and fundraising for an eye-related medical problem, the method as claimed in 1 comprises the steps of:
providing a front surface and a rear surface for each of the plurality of eye patches;
pressing the rear surface against the eye-shaped portion;
printing a distinctive visual design onto the front surface; and
increasing the awareness about the eye-related medical problem by displaying the distinctive visual design on each of the plurality of eye patches with the corresponding figure.

7. The method of raising awareness and fundraising for an eye-related medical problem, the method as claimed in 1 comprises the steps of:
prompting to purchase each of the plurality of eye patches in order to fundraise for the eye-related medical problem; and
receiving financial funds for the eye-related medical problem through purchases of the plurality of eye patches.

8. The method of raising awareness and fundraising for an eye-related medical problem, the method as claimed in 1 comprises the steps of:
prompting to fundraise for the eye-related medical problem by displaying each of the plurality of eye patches with the corresponding figure; and
receiving financial funds for the eye-related medical problem through a funds-receiving mechanism.

9. The method of raising awareness and fundraising for an eye-related medical problem, the method as claimed in 1 comprises the steps of:
generating a photograph for each of the plurality of eye patches on the corresponding figure;
uploading the photograph for each of the plurality of eye patches onto a computerized social network; and
increasing the awareness about the eye-related medical problem by displaying the photograph for each of the plurality of eye patches through the computerized social network.
